(19) United States
(12) Patent Application Publication
(10) Pub. No.: US 2021/0246292 A1
(43) Pub. Date: Aug. 12, 2021

(54) Vehicle Tire

(71) Applicant: Continental Reifen Deutschland GmbH, Hannover (DE)

(72) Inventors: Dieter Jeromin, Hannover (DE); Matthias Plückers, Barsinghausen (DE); Sebastian Finger, Hannover (DE); Fabian Peters, Hannover (DE)

(73) Assignee: Continental Reifen Deutschland GmbH, Hannover (DE)

(21) Appl. No.: 17/269,442

(22) PCT Filed: Jul. 29, 2019
(86) PCT No.: PCT/EP2019/070294

§ 371 Date: Feb. 18, 2021

(30) Foreign Application Priority Data
Aug. 30, 2018 (DE) 10 2018 214 700.0

(51) Int. Cl. C08L 23/28; B60C 1/00

(52) U.S. Cl. CPC C08L 23/28; C08L 2205/035; B60C 1/0008

(57) ABSTRACT

The invention relates to a pneumatic vehicle tire having an inner liner composed of a sulfur-crosslinked rubber mixture containing 80 to 100 phr (parts by weight, based on 100 parts by weight of all rubbers in the mixture) of at least one butyl rubber and/or halogenated butyl rubber, at least one filler, 1 to 60 phr of at least one coumarone-indene resin and 1 to 60 phr of at least one aliphatic hydrocarbon resin, wherein the total mass of coumarone-indene resin and aliphatic hydrocarbon resin does not exceed 65 phr.

The invention relates to a pneumatic vehicle tire having an inner liner composed of a sulfur-crosslinked rubber mixture.

In tubeless pneumatic vehicle tires, an inner liner of minimum air permeability disposed radially on the inside ensures that the air pumped into the tire does not escape. It is necessary to counteract the escape of the air since escape leads to a low pressure in the tire that greatly impairs the service life of the tire. Moreover, the inner liner protects the carcass from the inward diffusion of air and moisture, since air and moisture can damage the strength members of the carcass and/or of the belt. For the inner liner to remain airtight, it must also have good cracking and fatigue resistance in order that no cracks that impair airtightness form in driving operation.

Rubbers used for the inner liner are typically butyl rubber, chlorobutyl rubber or bromobutyl rubber, occasionally blended with other diene rubbers. Butyl and halobutyl rubbers have low gas permeability. The reasons why butyl and halobutyl rubber are blended with rubbers selected from the group consisting of polybutadiene, styrene-butadiene copolymer, 3,4-polyisoprene, cis-1,4-polyisoprene, natural rubber, epoxidized natural rubber, styrene-isoprene copolymer and styrene-isoprene-butadiene copolymer are to increase the tackiness of the formulation, to reduce costs, and to improve mechanical properties.

The inclusion of voluminous fillers having low or zero activity can further increase the airtightness of mixtures based on butyl or halobutyl rubber. These fillers include, for example, kaolin, N 660 carbon black, and chalk. Since inner liners, however, in order to prevent cracking in the event of dynamic stresses, should have a low modulus of elasticity and low hardness, but this is at odds with a high proportion of inactive fillers, mineral oil plasticizers are generally added to the rubber mixture, which reduce the modulus of elasticity and hardness of the mixture, but at the same time increase gas permeability again, which results in a narrow, optimal range for the amounts of mineral oil plasticizer and filler used.

Resins are a known alternative or addition to mineral oil plasticizers in rubber mixtures for inner liners of pneumatic vehicle tires.

WO 2010/024955 A1 discloses rubber mixtures for inner liners of pneumatic vehicle tires, including aromatic hydrocarbon resins, such as Struktol® 40 MS (Bitumen), having a softening point between 75 and 120° C., and simultaneously aliphatic hydrocarbon resins, such as Escorez™ 1102, having a glass transition temperature of more than 40° C. and a softening point of less than 140° C.

EP 2 957 592 A1 discloses rubber mixtures for inner liners of pneumatic vehicle tires, which, for good gastightness coupled with good cracking resistance at low temperatures, contain an ester of an aliphatic dibasic acid and resin having a softening point of more than 60° C. Also proposed as resins are combinations of different resins, including the use of “mixed resins”. These mixed resins in this case are resin mixtures in which a monomer of aromatic structure and a monomer of aliphatic structure are polymerized. Struktol® 40 MS is described as such a mixed resin and is used in combination with other aliphatic resins.

It is an object of the present invention to provide a pneumatic vehicle tire wherein the rubber mixture for the inner liner is further improved in terms of processibility, hardness, resilience at 70° C. and airtightness.

The object is achieved in that the rubber mixture for the inner liner contains
80 to 100 phr (parts by weight, based on 100 parts by weight of all rubbers in the mixture) of at least one butyl rubber and/or halogenated butyl rubber,
at least one filler,
1 to 60 phr of at least one coumarone-indene resin and
1 to 60 phr of at least one aliphatic hydrocarbon resin,
   wherein the total mass of coumarone-indene resin and aliphatic hydrocarbon resin does not exceed 65 phr.

It has been found that, surprisingly, the specific combination of coumarone-indene resin with aliphatic hydrocarbon resin in rubber mixtures based on butyl rubber and/or halogenated butyl rubber can achieve particularly good processibility coupled with simultaneously high airtightness/gastightness and appropriate hardness and resilience at 70° C. The reason for this could be that this specific resin combination creates an optimal transition between filler and rubber polymer. Moreover, the rubber mixtures have advantageous vulcanization characteristics. They have an elevated scorch time (t₁₀) and a reduced vulcanization time to 40% crosslinking (t₄₀), and accordingly give process reliability coupled with more economic production. A pneumatic vehicle tire having an inner liner composed of such a rubber mixture is notable for good producibility and high service life. Components adjoining the inner liner in the tire are exposed to lower oxidative stress and aging as a result of the reduced gas permeability, and the tire pressure drops much more slowly. It may be possible to reduce the thickness of the inner liner.

The unit “phr” (parts per hundred parts of rubber by weight) used in this document is the standard unit of quantity for mixture recipes in the rubber industry. The dosage of the parts by weight of the individual substances is always based here on 100 parts by weight of the total mass of all rubbers present in the mixture.

The rubber mixture for the inner liner contains 80 to 100 phr of at least one butyl rubber and/or a halogenated butyl rubber, where the rubbers may be used either in the form of freshly produced rubbers or in the form of regenerate.

The rubber mixture, for reduced gas permeability, preferably are contains 80 to 100 phr of at least one halogenated butyl rubber. This may be chloro- and/or bromobutyl rubber.

The rubber mixture for the inner liner may, as well as the butyl and/or halobutyl rubbers, also contain up to 20 phr of at least one further diene rubber selected from the group consisting of polyisoprene, polybutadiene, styrene-butadiene copolymer and epoxidized natural rubber. The diene rubbers may be functionalized at the chain end and/or along the polymer chain and/or at a coupling center with at least one group selected from alkoxysilyl groups containing epoxy groups, hydroxyl groups, carboxyl groups, silane sulfide groups, amino groups, siloxane groups, organosilicon groups, phthalocyanine groups and amino groups.

As fillers, the rubber mixture for the inner liner may use all fillers known to the person skilled in the art for such mixtures. These fillers include voluminous fillers of low or zero activity, such as specific types of carbon black, kaolin or chalk. Further fillers present in the rubber mixture may, for example, be silica, aluminum oxides, calcium carbonate, calcium hydroxide, sheet silicates, talc, graphite, magnesium oxide, magnesium hydroxide and zeolites in any combinations.

The rubber mixture for the inner liner contains 1 to 60 phr, preferably 5 to 30 phr, of at least one coumarone-indene resin. Such resins are obtained in the polymerization of the unsaturated compounds present in the light oil from bituminous coal tar, such as indene and coumarone (benzofuran).

In addition, the rubber mixture for the inner liner contains 1 to 60 phr, preferably 5 to 30 phr, of at least one aliphatic hydrocarbon resin. Aliphatic hydrocarbon resins here are resins that are obtained by polymerization of monomers containing C5 and/or C6 olefins. These monomers are obtained, for example, in the cracking of mineral oil.

As well as the substances mentioned, the rubber mixture for the inner liner may contain customary rubber admixtures in customary amounts. These substances include, for example, plasticizers, especially mineral oil plasticizers, aging stabilizers, activators, for example zinc oxide and fatty acids (e.g. stearic acid), waxes and masticating aids.

In an advantageous development of the invention, the rubber mixture for the inner liner is free of plasticizer oils and processing aids, especially free of mineral oil plasticizers. It has been found that the resin combination according to the invention can replace plasticizer oils, such as the mineral oil plasticizers that are often considered to be of environmental concern, without having to accept losses in other desired properties of the inner liner.

The rubber mixture for the inner liner has been crosslinked in the presence of sulfur and/or sulfur donors; for this purpose, vulcanization accelerators have generally been added to the starting mixture. The vulcanization accelerators may be selected here from the group consisting of thiazole accelerators, mercapto accelerators, sulfenamide accelerators, thiocarbamate accelerators, thiuram accelerators, thiophosphate accelerators, thiourea accelerators, xanthogenate accelerators and guanidine accelerators. Sulfur and/or sulfur donors and the vulcanization accelerators were used in customary amounts.

The rubber mixture for the inner liner is produced in a conventional manner, by first generally preparing a base mixture containing all the constituents except for the vulcanization system (sulfur and vulcanization-influencing substances), in one or more mixing stages, and subsequently producing the finished mixture by adding the vulcanization system. Subsequently, the mixture is processed further, for example by a calendering operation, and shaped into an inner liner. In the production of a pneumatic vehicle tire, the calendered inner liner is placed onto the tire building drum in the customary manner, and then the tire is completed with further components to give the tire blank. This is vulcanized by methods known to the person skilled in the art.

The pneumatic vehicle tire is notable for simple processibility coupled with high gastightness and service life.

The invention is now to be illustrated in detail with reference to comparative examples and working examples, which are summarized in table 1.

For all of the mixture examples in the tables, the amounts stated are parts by weight based on 100 parts by weight total rubber (phr). The comparative mixtures are identified by V, and the mixture for the inner liner of the invention by E. The mixtures differ only in the plasticizer oil and resin admixtures. Mixture 1(V) is a rubber mixture for inner liners comprising plasticizer oils. In mixture 2(V), some of the plasticizer oil has been replaced by an aliphatic hydrocarbon resin. Mixture 3(V) contains solely aliphatic hydrocarbon resin, and mixture 4(V) solely coumarone-indene resin. Mixture 5(E) for the pneumatic vehicle tire comprising the inner liner of the invention does not contain any plasticizer oil, but contains the specific combination of coumarone-indene resin with aliphatic hydrocarbon resin.

The mixture was produced under standard conditions in two stages in a laboratory tangential mixer. The conversion times until attainment of a relative crosslinking level of 10% (t₁₀) or 40% (t₄₀) were ascertained by monitoring the vulcanization process using a rotorless vulcameter to DIN 53 529. The Mooney viscosities (ML 1+4) of the mixtures have also been determined to DIN 53 523 with a shearing disk viscometer at 100° C.

All the mixtures were used to produce test specimens by vulcanization under pressure at 160° C. for 15 minutes, and these test specimens were used to determine material properties typical in the rubber industry. The following test methods were used for the tests on test specimens:
Shore A hardness at room temperature by durometer to DIN ISO 7619-1
Resilience at 70° C. to DIN 53 512 or ISO 4662 or ASTM D 1054
Air permeability to DIN 53 536 at air temperature 70° C. without and with aging at 70° C. for 14 days

Tires of 255/30 R 19 dimensions were also built, the inner liner of which comprised the mixtures of table 1, and these tires were used to conduct the following tests:
Tire service life: Drum test in accordance with the service life test to FMVSS 139 with regard to cracking/fracture resistance of inner liner and sidewall
Rolling resistance: to ISO 28580

The values ascertained were converted to performance, normalizing the comparative mixture V1 to 100% performance for each tire property tested. The tire properties of the other mixtures then relate to this mixture V1. Values less than 100% here mean a deterioration in the properties, whereas values more than 100% represent an improvement.

TABLE 1

| Constituents | Unit | 1 (V) | 2 (V) | 3 (V) | 4 (V) | 5 (E) |
|---|---|---|---|---|---|---|
| Bromobutyl | phr | 100 | 100 | 100 | 100 | 100 |
| rubber | | | | | | |
| N 660 carbon | phr | 55 | 55 | 55 | 55 | 55 |
| black | | | | | | |
| Plasticizer | phr | 16 | 8 | — | — | — |
| oil/processing | | | | | | |
| aid | | | | | | |
| Aliphat. resin^{a} | phr | — | 12 | 20 | — | 12 |
| Coumarone- | phr | — | — | — | 20 | 8 |
| indene resin^{b} | | | | | | |
| Stearic acid | phr | 2 | 2 | 2 | 2 | 2 |
| Zinc oxide | phr | 3 | 3 | 3 | 3 | 3 |
| Accelerator | phr | 1.2 | 1.2 | 1.2 | 1.2 | 1.2 |
| Retardant | phr | 0.2 | 0.2 | 0.2 | 0.2 | 0.2 |
| Sulfur | phr | 0.62 | 0.62 | 0.62 | 0.62 | 0.62 |
| Properties | | | | | | |
| t₁₀ | min | 3.95 | 3.3 | 2.2 | 3.3 | 2.3 |
| t₄₀ | min | 7.5 | 6 | 4.3 | 7.6 | 4.3 |
| Mooney ML | — | 69 | 71 | 73 | 61 | 69 |
| 1 + 4 | | | | | | |
| Shore hardness | ShA | 49 | 52.8 | 51.6 | 42.6 | 45.9 |
| Resilience | % | 36.5 | 32.7 | 34.8 | 33.2 | 34.5 |
| Air permea- | m²/Pa * s | 4.3 * | 3.1 * | 2.8 * | 3.7 * | 3.3 * |
| bility at 70° C. | | 10⁻¹⁷ | 10⁻¹⁷ | 10⁻¹⁷ | 10⁻¹⁷ | 10⁻¹⁷ |
| without aging | | | | | | |
| Air permeability | m²/Pa * s | 4.4 * | 3.5 * | 3.0 * | 3.9 * | 3.3 * |
| at 70° C. after | | 10⁻¹⁷ | 10⁻¹⁷ | 10⁻¹⁷ | 10⁻¹⁷ | 10⁻¹⁷ |
| aging | | | | | | |
| Tire properties | | | | | | |
| Tire service life | % | 100 | 124 | 103 | 172 | 140 |
| Rolling | % | 100 | 100.3 | 99.9 | 99.7 | 100.8 |
| resistance | | | | | | |

^{a}aliphatic C5 resin with narrow molecular weight distribution, Piccotac ™ 1095, Eastman Chemical Company
^{b}coumarone-indene resin, Novares ® C 90, Rutgers Chemicals

It is apparent from table 1 that the specific combination of the two resins in mixture 5(E) can achieve good processing characteristics (indicators are the Mooney viscosity and the low scorch times (t₁₀/t₄₀)) coupled with low air permeability. What is particularly surprising is the effect of the combination of the resins on resilience at 70° C., which serves as an indicator of rolling resistance. Low resilience is typically accompanied by low rolling resistance. If the two resins are combined, what is obtained is not a distinct reduction in resilience at 70° C. as expected from the individual measures according to 3(V) and 4(V), but one at the level of 3(V). The tire comprising mixture 5(E) also has high tire service life with regard to the cracking/fracture resistance of inner liner and sidewall and low rolling resistance.

It is simultaneously advantageous that mixture 5(E) for the inner liner can achieve properties that are at least equally good as those with mixture 1(V), but without any need to use plasticizer oils and processing aids, especially mineral oil plasticizers.

1.-6. (canceled)

7. A pneumatic vehicle tire having an inner liner composed of a sulfur-crosslinked rubber mixture comprising:
80 to 100 phr (parts by weight, based on 100 parts by weight of all rubbers in the mixture) of at least one butyl rubber and/or halogenated butyl rubber;
at least one filler;
1 to 60 phr of at least one coumarone-indene resin; and,
1 to 60 phr of at least one aliphatic hydrocarbon resin;
wherein the total mass of coumarone-indene resin and aliphatic hydrocarbon resin does not exceed 65 phr.

8. The pneumatic vehicle tire as claimed in claim 7, wherein the sulfur-crosslinked rubber mixture of the inner liner contains 80 to 100 phr of at least one halogenated butyl rubber.

9. The pneumatic vehicle tire as claimed in claim 7, wherein the sulfur-crosslinked rubber mixture of the inner liner contains up to 20 phr of at least one further diene rubber selected from the group consisting of polyisoprene, polybutadiene, styrene-butadiene copolymer and epoxidized natural rubber.

10. The pneumatic vehicle tire as claimed in claim 7, wherein the sulfur-crosslinked rubber mixture of the inner liner contains 5 to 30 phr of at least one coumarone-indene resin.

11. The pneumatic vehicle tire as claimed in claim 7, wherein the sulfur-crosslinked rubber mixture of the inner liner contains 5 to 30 phr of at least one aliphatic hydrocarbon resin.

12. The pneumatic vehicle tire as claimed in claim 7, wherein the sulfur-crosslinked rubber mixture of the inner liner is free of plasticizer oils and processing aids.
